(19) United States
(12) Patent Application Publication
(10) Pub. No.: US 2007/0035750 A1
(43) Pub. Date: Feb. 15, 2007

(54) Configurable device model for n-channel device

(75) Inventors: Todd D. Newman, Palo Alto, CA (US); John S. Haikin, Fremont, CA (US)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/201,543

(22) Filed: Aug. 10, 2005

(51) Int. Cl. H04N 1/60

(52) U.S. Cl. 358/1.9

(57) ABSTRACT

The present invention provides for a device model that transforms color image data between a device independent color space and a device dependent color space having n colorants. When transforming color from a device independent color space to a device dependent color space, a plurality of colorant sets is obtained, wherein each colorant set is a defined subset of the n colorants which includes some but not all of the n colorants, and wherein the number of defined subsets is smaller than the number of all possible subsets of the n colorants. A transform is generated for each of the colorant sets, wherein each transform maps to a device dependent color space corresponding to the respective colorant set. A search order can be obtained to define an order for searching the transforms. A color composition of the n colorants can be obtained to produce primary and secondary colors. Accordingly, a configurable device model for n-channel printing can be realized.

### DESCRIPTION OF THE RELATED ART

Conventional color printer systems employ cyan, magenta, yellow and black (CMYK) inks. Used alone or in combination with one another, these four colors define a range of different colors that the color print system can produce. This range of colors is known as a gamut.

In high-end printing, it may be desired to print colors that are outside the gamut of traditional four color print systems. One approach for extending the gamut of colors is to add new inks to the print system. The resulting printer, which typically has more than the four CMYK channels, has been referred to as an “n-channel” printer, where n represents the number of differently colored inks employed by the printer.

The added inks may be ones that are typically difficult to reproduce, such as orange, green, red and blue. For example, a 6-channel printer may use inks of cyan, magenta, yellow, black, orange and green, or CMYKOG. Inks may also be added to increase the apparent resolution of a color printer. For example, inks with different tints have been used, such as light cyan, and light magenta.

While n-channel printers may be able to print colors outside the gamut of traditional four color print systems, these printers are not without problems.

One problem associated with n-channel printers is the high dimensionality of the color management process. For example, an n-channel printer can result in a look-up table (LUT) having n dimensions (e.g., the 6-channel CMYKOG printer mentioned above can result in a 6-dimensional LUT). Since the size of the search space of an LUT can exponentially increase as dimensions are added, searches can become more time-consuming.

A second problem associated with n-channel printers is the ability to produce color separations that are reasonably robust under slight variations in printing conditions. For example, it is possible that two different combinations of colorants within an n-channel print system can produce the same colorimetric value. If different combinations are used for adjacent pixels with the same calorimetric value, and a printing press is used that drifts slightly off its initial calibration, the adjacent pixels may not match. For similar reasons, it is also possible that gradations which should appear smooth within an image do not appear smooth when printed.

A third problem associated with n-channel printers is defining the traditional primary colors (R, G, B) and secondary colors (C, M, Y) that are used by some gamut-mapping algorithms. These primary and secondary colors are easy to define for devices that use primary sets of R, G, and B or C, M, and Y inks. However, the actual color of inks used in n-channel printers may not be R, G, and B or C, M, and Y.

The foregoing problems are compounded when it is recognized that the actual colors of inks used in n-channel printers can change from print job to print job. Thus, a device model for an n-channel printer that addresses the foregoing problems and that is configurable based on the actual inks selected for a particular print job is desired.

### SUMMARY OF THE INVENTION

In view of the foregoing problems, the present invention provides for a configurable device model for a device using n colorants. A plurality of colorant sets is obtained, wherein each colorant set is a defined subset of the n colorants, and a transform is generated for each of the colorant sets. In transforming colors, a search order can be obtained for defining an order for searching the transforms. In defining a gamut boundary of the device, a color composition of the n colorants can be obtained for producing primary and secondary colors.

According to one aspect of the invention, a method is provided for creating a device model for transforming color image data from a device independent color space to a device dependent color space having n colorants. A plurality of colorant sets is obtained, wherein each colorant set is a defined subset of the n colorants which includes some but not all of the n colorants, and wherein the number of defined subsets is smaller than the number of all possible subsets of the n colorants. A transform is generated for each of the colorant sets, wherein each transform maps to a device dependent color space corresponding to the respective colorant set.

The number of colorants, n, can be greater than four. Each of the subsets of the n colorants can include three or four colorants. In one aspect of the invention, in a case where a subset of the n colorants includes four colorants, one of the four colorants is black.

Each of the transforms can be implemented as a look-up table (LUT). Each of the subsets of the n colorants can comprise at least two colorants that are close to each other in device independent color space. At least two of the subsets of the n colorants can share a same colorant. The colorant sets can span a gamut defined by all of the n colorants.

According to another aspect of the invention, a method is provided for transforming a color from a device independent color space to a device dependent color space having n colorants using a device model. A search order is obtained for searching the device model, wherein the device model comprises a set of transforms, each transform corresponding to a subset of the n colorants which includes some but not all of the n colorants, and mapping a portion of the device independent color space to a device dependent color space corresponding to the subset of the n colorants. The search order defines an order for searching the set of transforms, and searching is performed in the defined order until the color falls within the portion of the device independent color space supported by a transform within the set of transforms. The resulting transform is applied to the color.

The number of the subsets of the n colorants can be smaller than the number of all possible subsets of the n colorants. The number of colorants, n, can be greater than four. Each of the subsets of the n colorants can comprise three or four colorants. In one aspect of the invention, in a case where a subset of the n colorants comprises four colorants, one of the four colorants is black.

Each of the transforms within the set of transforms can be implemented as a look-up table (LUT). Each of the subsets of the n colorants can comprise at least two colorants that are close to each other in device independent color space. At least two of the subsets of the n colorants can share a same colorant. The colorant sets can span a gamut defined by all of the n colorants.

According to yet another aspect of the invention, a method is provided for defining a device-independent color specification corresponding to a device using n colorants, the device-independent color specification specifying primary and secondary colors for the device. A color composition of the n colorants is obtained for producing each of the primary and secondary colors. Each of the obtained color compositions is transformed to device independent color space.

The device-independent color specification can be used in gamut mapping to or from the device using the n colorants. The primary colors can include red, green and blue, and the secondary colors can include cyan, magenta and yellow.

Each of the color compositions can include a percentage of each of the n colorants used for producing the primary or secondary color. In a case where one of the n colorants is black, the black colorant can be used to produce black, and black can otherwise be produced using a color composition of the n colorants.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 is a diagram that provides a general explanation of a color device model for converting colors in accordance with an exemplary embodiment of the present invention.

FIG. 2 is a flowchart depicting the generation of LUT's based on obtained colorant sets in accordance with an exemplary embodiment of the present invention.

FIG. 3 is a flowchart depicting the searching of values within a color device model in accordance with an exemplary embodiment of the present invention.

FIG. 4 is a block diagram illustrating a data processing system which may be used to host a color device model in accordance with an exemplary embodiment of the present invention.

### DETAILED DESCRIPTION OF THE INVENTION

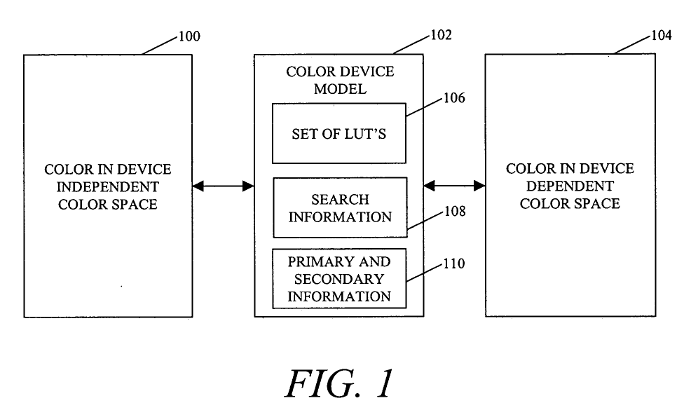

Referring to FIG. 1, a diagram that provides a general explanation of a color device model for converting colors in accordance with an exemplary embodiment of the present invention is shown. The color device model 102 transforms colors between a device independent color space 100 (e.g., Luv, Jab) and a device dependent color space 104 having n colorants (e.g., CMYKOG).

Each of the n colorants in the device dependent color space can be represented by a value ranging from 0 (zero) percent to 100 percent. When transforming from device independent to device dependent color space, for example, each pixel of an image in device independent color space can be represented by a combination of colorants in the device dependent color space, wherein the value of each colorant of the color combination represents the amount to which that colorant contributes to the color appearance of the pixel.

Color device model 102 includes a set of LUT's 106, search information 108 and primary and secondary color information 110. Each LUT within the set of LUT's 106 is associated with a colorant set, which is a defined subset of the n colorants. Each LUT can transform color to a device dependent color space corresponding to the colorant set. In one aspect of the invention, the number of colorant sets is smaller than the number of all possible subsets of the n colorants. The search information 108 provides for at least a search order for searching the set of LUT's. In addition, the primary and secondary color information 110 provides for color compositions (or combinations) of the n colorants corresponding to primary and secondary colors in device independent color space.

By using a smaller number of colorant sets than the number of all possible subsets of the n colorants, the present invention reduces the dimensionality of the search space of the color device model 102, and can improve search times for the color device model 102. By specifying a search order, the present invention is more likely to produce color separations that are reasonably robust under slight variations in printing conditions, particularly when printing adjacent pixels with similar calorimetric values. In addition, by providing combinations of the n colorants for creating primary and secondary colors, the present invention can define the primary and secondary colors required by some gamut-mapping algorithms.

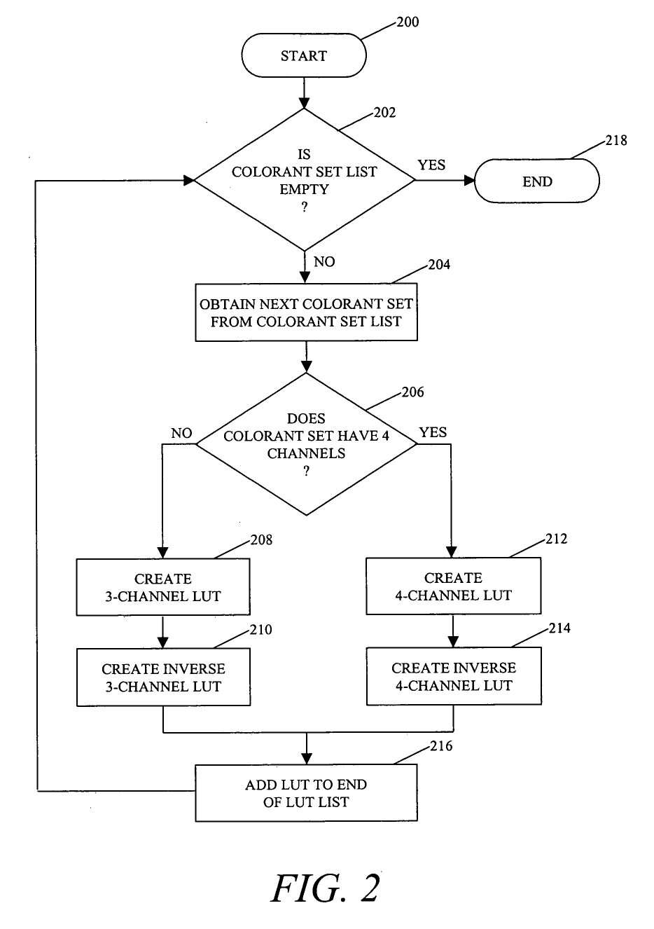

Turning to FIG. 2, a flowchart depicting the generation of LUT's based on obtained colorant sets in accordance with an exemplary embodiment of the present invention is shown. First, however, a description of the colorant sets will be provided.

As noted above, each LUT corresponds to a colorant set, which is a subset of the n colorants. These colorant sets should be provided to the color device model 102. For example, the colorant sets can be included within a device profile that is provided to the color device model 102.

Each colorant set includes some, but not all, of the n colorants. In this exemplary embodiment, each colorant set includes 3 or 4 of the n colorants. One reason for using 3 or 4 colorants per colorant set has to do with typical characteristics of n-channel printer devices. In general, the ink limit levels of printers discourage the use of more than 4 colorants (or inks) per pixel. The pixel may also appear muddy if more than 4 inks are used. In addition to ink limiting, the use of 3 or 4 colorants per colorant set reduces the size of the search space. Accordingly, the use of 3 or 4 colorants per colorant set is preferred.

A list of exemplary colorant sets which can be employed by a color device model corresponding to an exemplary CMYKOG device is shown below in Table 1:

TABLE 1

| Colorant Set | Colorants Used |
|---|---|
| 1 | 1, 2, 3, 4 |
| 2 | 1, 3, 6, 4 |
| 3 | 2, 5, 3, 4 |
| 4 | 3, 5, 6 |
| 5 | 2, 3, 5 |
| 6 | 1, 2, 5 |

In this example, the CMYKOG device has n=6 colorants, with colorants 1 through 6 respectively corresponding with the colors C, M, Y, K, O and G. It should be noted that the information relating to the colorant sets does not need to be implemented in table form. For example, a device profile providing the colorant sets may use XML, or another data format.

In the example of Table 1, 6 colorant sets are provided, each of which correspond to a different subset of the n colorants. Based on the colorant sets of Table 1, the following LUT's should be generated: CMYK, CYGK, MOYK, YOG, MYO and CMO. It can be seen that there are other possible LUT's that do not necessarily have to be created, such as MGO, KYG, etc., since they do not correspond with the colorant sets of Table 1.

By using a number of colorant sets that is smaller than the number of all possible subsets of n colorants, the dimensionality of the search space of the color device model 102 can be reduced, and search times of the color device model 102 can be improved. Thus, the use of colorant sets can narrow down the search space transformation from device independent to device dependent color space.

To improve data sampling for the color device model 102, the provided colorant sets may follow certain design characteristics. For example, the colorant sets may be designed so as to select colorants that are close to each other in device independent color space, thereby forming a more dense sampling. In addition, the colorant sets may share pairs of colorants, so that the gamuts of the colorant sets are contiguous. Finally, a sufficient number of colorant sets may be provided so as to span the gamut created by all of the n colorants. It should be noted that although these design characteristics may provide for improved data sampling, the present invention is not limited to colorant sets with such design characteristics.

Referring now to FIG. 2, a flowchart depicting the generation of LUT's based on obtained colorant sets in accordance with an exemplary embodiment of the present invention is shown. Following start bubble 200, a determination is made as to whether the list of colorant sets is empty (decision diamond 202). If the list is not empty, meaning that all of the colorant sets do not have corresponding LUT's, a colorant set is obtained from the list of colorant sets (block 204). A determination is then made as to whether the obtained colorant sets has four colorants (decision diamond 206). If the answer to this inquiry is yes, a 4-channel LUT is created for the obtained colorant set (block 212), and a corresponding inverse 4-channel LUT is also created (block 214). If the answer to this inquiry is no, a 3-channel LUT is created for the obtained colorant set (block 208), and a corresponding inverse 3-channel LUT is also created (block 210). As noted above, the use of 3 or 4 colorants per colorant set is preferred, to effect ink limiting and to reduce the size of the search space.

A consideration in creating the LUT is that one of the colorants within a colorant set having 4 colorants should be black. This correlates with the above printer discussion that no more than 4 colorants (inks) should be used per colorant set. Accordingly, when dealing with printers having 4 or more channels, a determination can be made as to which channel is black for the corresponding 4-D LUT.

An additional consideration for creating the LUT's is that the device may not include the primary colors R, G, B and/or the secondary colors C, M, Y as colorants. As such, creation of these colors for the LUT may require that a combination of colorants within the device be provided that correspond to the primary and secondary colors. These combinations may be provided for within a device profile. A table of exemplary combinations of colorants for producing the primary and secondary colors is shown below in Table 2:

TABLE 2

| | |
|---|---|
| Color | Colorant Percentages |

| | | | |
|---|---|---|---|
| Black | 1 = 0 | 4 = 100 | 7 = 0 |
| | 2 = 0 | 5 = 0 | 8 = 0 |
| | 3 = 0 | 6 = 0 | |
| Red | 1 = 0 | 4 = 0 | 7 = 0 |
| | 2 = 100 | 5 = 0 | 8 = 0 |
| | 3 = 100 | 6 = 0 | |
| Green | 1 = 0 | 4 = 0 | 7 = 0 |
| | 2 = 0 | 5 = 0 | 8 = 0 |
| | 3 = 0 | 6 = 100 | |
| Blue | 1 = 85 | 4 = 0 | 7 = 0 |
| | 2 = 75 | 5 = 0 | 8 = 0 |
| | 3 = 0 | 6 = 0 | |
| Cyan | 1 = 100 | 4 = 0 | 7 = 0 |
| | 2 = 0 | 5 = 0 | 8 = 0 |
| | 3 = 0 | 6 = 0 | |
| Magenta | 1 = 0 | 4 = 0 | 7 = 0 |
| | 2 = 100 | 5 = 0 | 8 = 0 |
| | 3 = 0 | 6 = 0 | |
| Yellow | 1 = 0 | 4 = 0 | 7 = 0 |
| | 2 = 0 | 5 = 0 | 8 = 0 |
| | 3 = 100 | 6 = 0 | |

It can be seen that green, cyan, magenta and yellow are made with 100% of channels 6, 1, 2 and 3, respectively. It can also be seen that red is made with 100% of channels 2 and 3, and that blue is made with 85% of channel 1 and 75% of channel 2. With the exception of black, the actual names of the colorants do not necessarily have to be known. What is required is the colorant's channel value (i.e., 1 through 6), and how much of that colorant is used to make a primary or secondary color. It should be noted that while the device of Table 2 only uses six colorants, the tag allows up to a maximum number of colorants supported by the operating system (i.e., 8 colorants). For example, the ICC profile format supports the use of up to 16 different color separations, and Microsoft's Windows operating system only supports up to eight color channels per pixel. In most cases, this maximum number of colorants is adequate, since the extended-gamut presses for n-channel printers use up to six channels.

Looking at the black color value in Table 2, it can be seen that the fourth channel is at 100%. The fourth channel is therefore the black channel. Although it is possible that black can be created with a combination of colorants, black should be created solely with the black channel. Thus, using a combination of colorants to produce black can be treated as an error condition, provided that a black channel exists.

Once the black channel is determined, and the color combinations of the colorants are obtained for the primary and secondary colors, these values can be entered at the appropriate locations within the LUT. The remaining entries within the LUT can be filled using known techniques for populating LUT's. After the LUT and inverse LUT are populated, the LUT and inverse LUT are added to a list of LUT's (block 216), and the process returns to decision diamond 202. This continues until the list of colorant sets is empty (i.e., all of the colorant sets have corresponding LUT's and inverse LUT's), at which point the process ends (end bubble 218).

The resulting color device model can define the traditional primary colors and secondary colors in the device independent color space that are used by some gamut-mapping algorithms. These primary and secondary colors can be defined if some, or none, of these colors are actually used by a particular device.

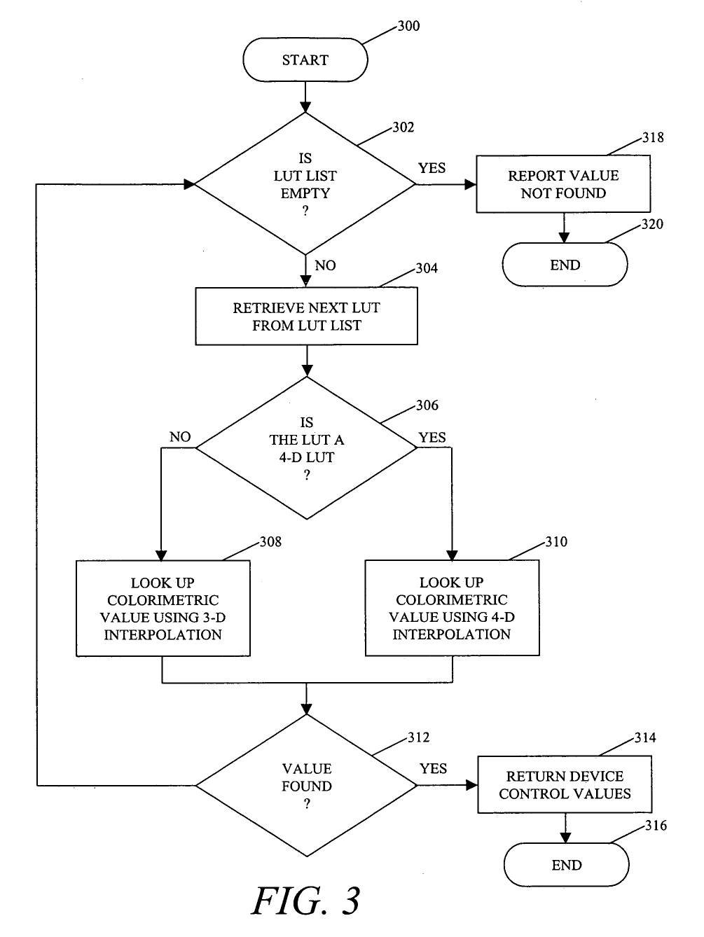

Turning now to FIG. 3, a flowchart depicting the searching of values within a color device model in accordance with an exemplary embodiment of the present invention is shown. Following start bubble 300, a determination is made as to whether an LUT list, which corresponds to the list of LUT's associated with the colorant sets, is empty (decision diamond 302). If the LUT list is not empty, meaning that all of the LUT's have not been searched, an LUT is retrieved from the LUT list (block 304), followed by an inquiry as to whether the retrieved LUT is a 4-D LUT (decision diamond 306).

If the LUT is not a 4-D LUT, a 3-D LUT search technique is performed for the desired colorimetric value (block 310). For example, a Newtonian search or other 3-D search technique can be employed. If the LUT is a 4-D LUT, a 4-D search technique is performed for the desired colorimetric value (block 308). Exemplary techniques for searching a 4-D LUT are discussed in U.S. patent application Ser. No. 10/841,184 and U.S. patent application Ser. No. 11/039,492.

After searching the retrieved LUT, a determination is made as to whether a value was found (decision diamond 312). If a value was found, the value is returned (block 314) and the process ends (end bubble 316). If the value was not found, the process returns to decision diamond 302 and repeats until a value is found, or until the LUT list is empty. If the LUT list is empty, meaning that all of the LUT's have been searched, it is reported that no value was found (block 318) and the process ends (end bubble 320).

As can be seen in FIG. 3, a search order is defined by traversing the list of LUT's in order. In other words, the colorant sets provided to the color device model 102 are presented in a specified order. The LUT's associated with each of the colorant sets should be searched in this order.

To improve the performance of the search algorithm, data structures can be created which represent the gamut boundary of colors in each of the LUT's. By determining if the colorimetric value is in a gamut associated with a given LUT, the search time can be reduced by only searching for a LUT that contains the calorimetric color. The gamut boundary description used can be a maximum/minimum lightness value, a bounding cube, or can contain maximum values for various lightnesses, depending on the availability of optimized hardware and/or software. Although such techniques can improve search times, they are not necessary for the present invention.

Defining a search order provides certain benefits for the present invention. First, the present invention is more likely to produce color separations that are reasonably robust under slight variations in printing conditions, particularly when printing adjacent pixels with similar calorimetric values. In this regard, ambiguity is reduced since the first LUT containing a given colorimetric value is typically used. Continuity is also improved because the given colorimetric value is more consistently retrieved from the same LUT. As noted above, the colorant sets can be provided to be sufficiently dense in device independent color space. In such cases, ambiguity can be further reduced and continuity further improved.

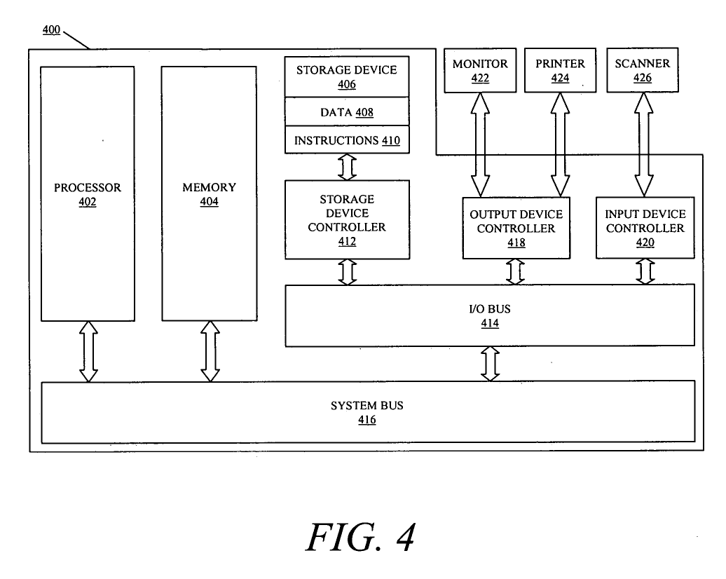

FIG. 4 is a block diagram illustrating a data processing system which may be used to host a color device model in accordance with an exemplary embodiment of the present invention. The data processing system 400 includes a processor 402 coupled to a memory 404 via system bus 416. The processor 402 is also coupled to external Input/Output (I/O) devices via the system bus 416 and an I/O bus 414. A storage device 406 having computer system readable media is coupled to the processor 402 via a storage device controller 412, the I/O bus 414 and the system bus 416. The storage device 406 is used by the processor 402 to store and read data 408 and program instructions 410 used to implement color conversion using the color device model as described above. The processor 402 may be further coupled to color output devices, such as computer display 422 and color printer 424, via an output device controller 418 coupled to the I/O bus 414. The processor 402 may also be coupled to a color input device 426, such as color scanner, via an input device controller 420.

In operation, the processor 402 loads the program instructions from the storage device 406 into memory 404. The processor 402 then executes the loaded program instructions 410 to convert a color between a device independent color space and a device dependent color space having n colorants, using a color device model. The resulting color can be used, for example, by the printer 424, as described above.

As noted above, the color device model of the present invention is provided with colorant sets defining subsets of n colorants, a search order, and combinations of the n colorants for creating primary and secondary colors. This information can be provided within a device profile. As such, the color device model is seen to be configurable, allowing for users to create and modify color device profiles. Users may also have increased flexibility in the number and color of colorants used. In addition, a gamut mapping algorithm can also be selected, rather than having a requirement that a certain gamut mapping algorithm be used.

By using a smaller number of colorant sets than the number of all possible subsets of the n colorants, the dimensionality of the search space of the color device model can be reduced, and search times for the color device model can be improved. By specifying a search order, color separations are more likely to be reasonably robust under slight variations in printing conditions, particularly when printing adjacent pixels with similar colorimetric values. In addition, by providing combinations of the n colorants for creating primary and secondary colors, the primary and secondary colors required by some gamut-mapping algorithms can be defined. The color device model of the present invention is therefore seen to provide more reliable color reproduction with improved requirements of processing power, time and/or memory.

The invention has been described above with respect to particular illustrative embodiments. It is understood that the invention is not limited to the above-described embodiments and that various changes and modifications may be made by those skilled in the relevant art without departing from the spirit and scope of the invention.

What is claimed is:

1. A method for creating a device model for transforming color image data from a device independent color space to a device dependent color space having n colorants, the method comprising the steps of:
obtaining a plurality of colorant sets, wherein each colorant set is a defined subset of the n colorants which includes some but not all of the n colorants, and wherein the number of defined subsets is smaller than the number of all possible subsets of the n colorants; and
generating a transform for each of the colorant sets, wherein each transform maps to a device dependent color space corresponding to the respective colorant set.

2. A method according to claim 1, wherein n is greater than four.

3. A method according to claim 2, wherein each of the subsets of the n colorants comprises three or four colorants.

4. A method according to claim 3, wherein in a case where a subset of the n colorants comprises four colorants, one of the four colorants is black.

5. A method according to claim 1, wherein each of the transforms is implemented as a look-up table (LUT).

6. A method according to claim 1, wherein each of the subsets of the n colorants comprises at least two colorants that are close to each other in device independent color space.

7. A method according to claim 1, wherein at least two of the subsets of the n colorants share a same colorant.

8. A method according to claim 1, wherein the colorant sets span a gamut defined by all of the n colorants.

9. Computer-executable process steps stored on a computer readable medium, said computer-executable process steps for creating a device model for transforming color image data from a device independent color space to a device dependent color space having n colorants, said computer-executable process steps comprising process steps executable to perform a method according to claim 1.

10. An apparatus for creating a device model for transforming color image data from a device independent color space to a device dependent color space having n colorants, the apparatus comprising:
a program memory for storing process steps executable to perform a method according to claim 1; and
a processor for executing the process steps stored in said program memory.

11. A method for transforming a color from a device independent color space to a device dependent color space having n colorants using a device model, the method comprising the steps of:
obtaining a search order for searching the device model,
wherein the device model comprises a set of transforms, each transform corresponding to a subset of the n colorants which includes some but not all of the n colorants, and mapping a portion of the device independent color space to a device dependent color space corresponding to the subset of the n colorants,
and wherein the search order defines an order for searching the set of transforms,
and wherein searching is performed in the defined order until the color falls within the portion of the device independent color space supported by a transform within the set of transforms; and
applying the transform to the color.

12. A method according to claim 11, wherein the number of the subsets of the n colorants is smaller than the number of all possible subsets of the n colorants.

13. A method according to claim 11, wherein n is greater than four.

14. A method according to claim 13, wherein each of the subsets of the n colorants comprises three or four colorants.

15. A method according to claim 14, wherein in a case where a subset of the n colorants comprises four colorants, one of the four colorants is black.

16. A method according to claim 11, wherein each of the transforms within the set of transforms is implemented as a look-up table (LUT).

17. A method according to claim 11, wherein each of the subsets of the n colorants comprises at least two colorants that are close to each other in device independent color space.

18. A method according to claim 11, wherein at least two of the subsets of the n colorants share a same colorant.

19. A method according to claim 11, wherein the colorant sets span a gamut defined by all of the n colorants.

20. Computer-executable process steps stored on a computer readable medium, said computer-executable process steps for transforming a color from a device independent color space to a device dependent color space having n colorants using a device model, said computer-executable process steps comprising process steps executable to perform a method according to claim 11.

21. An apparatus for transforming a color from a device independent color space to a device dependent color space having n colorants using a device model, the apparatus comprising:
a program memory for storing process steps executable to perform a method according to claim 11; and
a processor for executing the process steps stored in said program memory.

22. A method for defining a device-independent color specification corresponding to a device using n colorants, the device-independent color specification specifying primary and secondary colors for the device, the method comprising the steps of:
obtaining, for each of the primary and secondary colors, a color composition of the n colorants for producing the primary or secondary color; and
transforming each of the obtained color compositions to device independent color space.

23. A method according to claim 22, wherein the device-independent color specification is used in gamut mapping to or from the device using the n colorants.

24. A method according to claim 22, wherein the primary colors comprise red, green and blue, and the secondary colors comprise cyan, magenta and yellow.

25. A method according to claim 22, wherein each of the color compositions includes a percentage of each of the n colorants used for producing the primary or secondary color.

26. A method according to claim 22, wherein in a case where one of the n colorants is black, the black colorant is used to produce black, and black is otherwise produced using a color composition of the n colorants.

27. Computer-executable process steps stored on a computer readable medium, said computer-executable process steps for defining a device-independent color specification corresponding to a device using n colorants, the device-independent color specification specifying primary and secondary colors for the device, said computer-executable process steps comprising process steps executable to perform a method according to claim 22.

28. An apparatus for defining a device-independent color specification corresponding to a device using n colorants, the device-independent color specification specifying primary and secondary colors for the device, the apparatus comprising:
a program memory for storing process steps executable to perform a method according to claim 22; and
a processor for executing the process steps stored in said program memory.
